(19) United States
(12) Patent Application Publication
(10) Pub. No.: US 2025/0332914 A1
(43) Pub. Date: Oct. 30, 2025

(54) ELECTRIFIED TRANSFER CASE

(71) Applicant: Magna Powertrain of America, Inc., Troy, MI (US)

(72) Inventors: Dil Raaj Singh Mand, Troy, MI (US); Opinder Sharma, Rochester Hills, MI (US); Shawn Donaldson, Waterford, MI (US); Devin Ryman, Macomb, MI (US); Lee McCay, Windsor (CA)

(21) Appl. No.: 19/191,408

(22) Filed: Apr. 28, 2025

Related U.S. Application Data
(60) Provisional application No. 63/639,730, filed on Apr. 29, 2024.

(51) Int. Cl. B60K 17/344; B60K 6/365; B60K 6/387; B60K 6/40; B60K 6/48; B60K 6/52; B60K 23/08

(52) U.S. Cl. CPC B60K 17/344; B60K 6/365; B60K 6/387; B60K 6/40; B60K 6/48; B60K 6/52; B60K 23/08; B60Y 2200/92

(57) ABSTRACT

An electrified transfer case includes an input shaft, an output shaft, an electric motor, a gear reduction unit, and an axially moveable sleeve that is disposed axially between the input shaft and the output shaft. The sleeve selectively engages the input shaft, output shaft, and gear reduction unit based on the axial positon of the sleeve to selectively transfer power among the input shaft, output shaft, and electric motor. The sleeve is freely rotatable and supported on a support shaft that spans between and is freely rotatable relative to the input shaft and the output shaft. The sleeve includes multiple axially spaced clutch teeth. As the sleeve is controllably axially moved, different clutch teeth will engage with the input shaft, output shaft, and/or gear reduction unit to drivingly connect the components for operating in different modes, including EV, hybrid, conventional, generator, and neutral modes.

### CROSS-REFERENCE TO RELATED APPLICATIONS

This application claims the benefit of U.S. Provisional Patent Application No. 63/639,730, filed Apr. 29, 2024, the entire content of which is hereby incorporated by reference in its entirety.

### FIELD

The present disclosure relates to an electrified transfer case for a hybrid vehicle to selectively distribute power provided by an internal combustion engine and an electric motor included in the electrified transfer case to a primary and secondary driveline.

### BACKGROUND

This section provides background information related to the present disclosure, which is not necessarily prior art. Automobile manufacturers are actively working to develop alternative powertrain systems in an effort to reduce the level of pollutants exhausted into the air by conventional powertrains equipped with internal combustion engines. Hybrid vehicles are equipped with an internal combustion engine and an electric motor that can be operated independently or in combination to drive the vehicle. Significant development has been directed to these hybrid electric vehicles, but often requiring a significant modification to the existing powertrain. Hybrid vehicles have been adapted to be used in all-wheel drive or four-wheel drive vehicles with most systems on the market being a P2 hybrid arrangement where an electric motor is located between the internal combustion engine and a multi gear transmission in a longitudinal arrangement. A transfer case is located at the rear of the transmission to direct power to a primary rear axle and a secondary front axle. Other alternatives include integrating a single motor or dual motors into a multispeed transmission and retaining the standard transfer case to split power between the primary and secondary axle. Implementing a P2 hybrid system with an existing transmission or developing a new hybrid transmission and combining with a traditional four-wheel drive system may be extremely expensive and difficult to package due to additional length. Thus, a need exists to develop improvements to hybrid powertrains.

### SUMMARY

This section provides a general summary of the many aspects associated with the inventive concepts embodied in the teachings of the present disclosure and is not intended to be considered a complete listing of its full scope of protection nor all of its features and advantages.

It is an object of the present disclosure to develop hybrid powertrains for use in vehicles, in particular four-wheel drive vehicles that utilize many conventional powertrain components so as to minimize specialized packaging and reduce cost. As will be shown, the electrified transfer case also provides additional operating modes not available in conventional hybrid powertrains.

An electrified transfer case of the present disclosure has multiple modes dependent on the operational condition of a mode selection device and a controllable clutch. Modes include providing a power split to a front and/or rear axle with propulsion from a single or combined power source, as well as modes where power may be regenerated for battery usage or allowing the vehicle to be flat towed.

In one form, an electrified transfer case is provided for a vehicle having an engine, a transmission, and front and rear drivelines. The electrified transfer case may include a first output shaft adapted for connection to the rear driveline, a second output shaft adapted for connection to the front driveline, and a first input shaft connected to the output of the transmission. The transfer case may further include a gear set engaged to an electric motor for torque multiplication, a multi-position torque transferring mode connection system, and a controllable torque transfer system between the first output shaft and the second output shaft.

The gear set may be a planetary or layshaft arrangement connecting the electric motor to the input shaft of the transfer case. The torque transfer system may be a chain or gear drive, with a controllable multi-plate clutch to selectively provide power to the second output shaft and front driveline. The electrified transfer case will provide five primary modes, including: an electrical only driven mode, an internal combustion engine mode, a hybrid electric mode, a generator mode, and two true neutral modes with no connection between the input of the electrified transfer case to the front and rear output shafts. Further secondary modes will be achieved via actuation of a controllable clutch to provide torque distribution between the front and rear axles to provide a 2WD, an AWD variable mode, or a locked clutch 4WD mode or controlling of the electric motor to provide regeneration to a battery.

In another aspect, a hybrid vehicle is provided. The hybrid vehicle can include a powertrain, first and second drivelines and an electrified transfer case. The powertrain may include an internal combustion engine and an electric motor as motive power sources. The first driveline may transfer power to a first set of ground engaging wheels. The second driveline may transfer power to a second set of ground engaging wheels. The electrified transfer case may include first and second output shafts and an input shaft. The first output shaft may be adapted for connection to the first driveline and the second output shaft may be adapted for connection to the second driveline. The first input shaft may be adapted for connection to the output of a transmission powered by an internal combustion engine. The electrified transfer case is provided as described above, and provides the ability for the hybrid vehicle to operate in various modes depending on the position of the mode selection device and the controllable clutch assembly.

These and other features and advantages of the present disclosure will become more readily appreciated when considered in connection with the following detailed description and drawings.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is a schematic of a hybrid drive system for a four-wheel drive vehicle in accordance with the teachings of the present disclosure;

FIG. 2 is a cross section of the electrified transfer case of the present disclosure;

FIG. 3 is a detailed view of the mode selection device of the electrified transfer case;

FIG. 4 illustrates the power flow of a first mode (electric mode), providing propulsion from an electric motor;

FIG. 5 illustrates the power flow of a second mode (hybrid mode), providing propulsion from an electric motor and the internal combustion engine;

FIG. 6 illustrates the power flow of a third mode (conventional), providing propulsion from only the internal combustion engine;

FIG. 7 is the power flow of a fourth mode (generator/flat tow), with no power flow to the front and rear axles but maintaining engagement of the electric motor and the input shaft; and

FIG. 8 is the power flow of a fifth mode (neutral/flat tow), with no power flow to the front and rear axles.

### DETAILED DESCRIPTION

The following description is exemplary in nature and is not intended to limit the present disclosure, application, or uses.

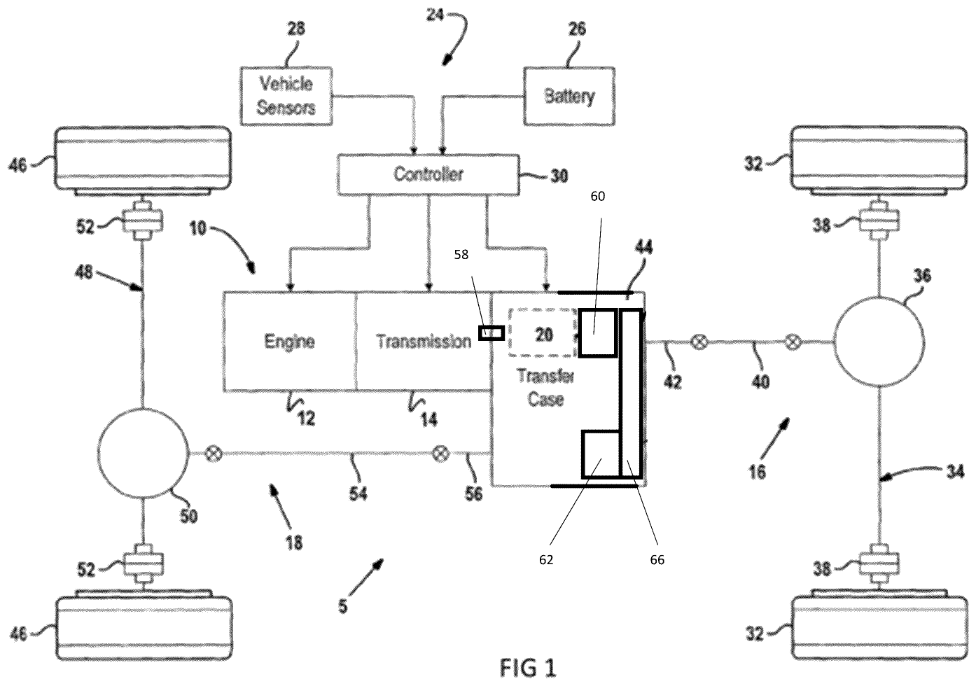

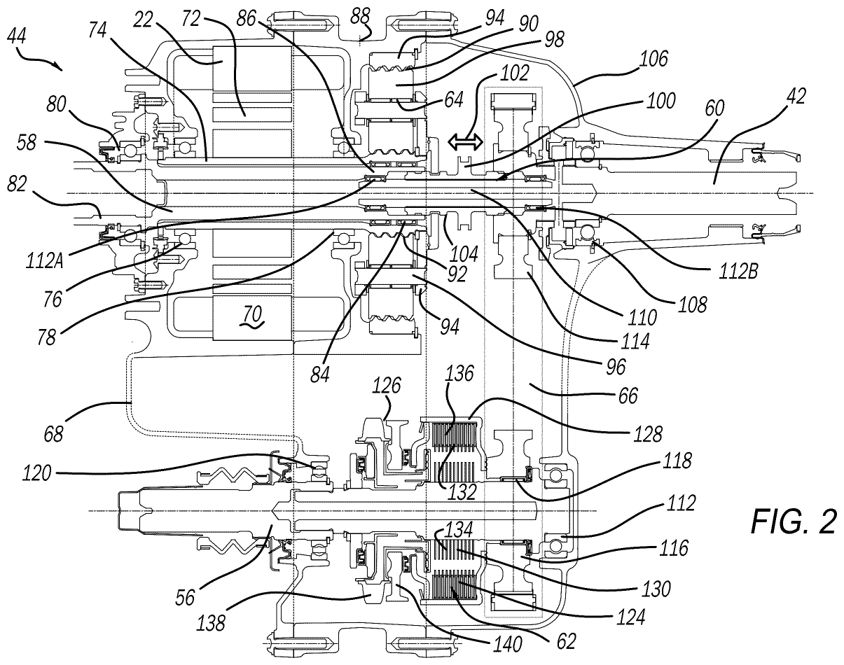

Referring to FIG. 1 of the drawings, a hybrid powertrain system 5 for a hybrid motor vehicle is shown, including a first power source 10, a transmission 14, a rear driveline 16, a front driveline 18, and a second power source 20. The first power source may include an internal combustion engine 12 and the second power source 20 may include an electric motor/generator 22 (see FIG. 2). Transmission 14 can be of any known type including, but not limited to, an automatic, manual, automated manual or continuously variable transmission. The vehicle can further include a powertrain control system 24 generally shown to include a battery 26, a group of vehicle sensors 28, and a controller 30. Rear driveline 16 can include a first pair of wheels 32 connected to a rear axle assembly 34 having a differential unit 36 and a pair of rear axle or wheel disconnects 38. Differential unit 36 can be connected to one end of a rear prop shaft 40, the opposite end of which can be connected to a first or rear output shaft 42 of a transfer case 44. Similarly, front driveline 18 can include a second pair of wheels 46 connected to a front axle assembly 48 having a differential unit 50 and a pair of wheel disconnects 52. Alternatively, a center axle disconnect may be provided in place of wheel disconnects 38 and 52 to achieve similar functionality. Differential unit 50 can be connected to one end of a front prop shaft 54, the opposite end of which can be connected to a second or front output shaft 56 of electrified transfer case 44. The hybrid four-wheel drive powertrain system 5 of the present disclosure may include two main power sources, namely internal combustion engine 12 and electric motor/generator 22. Power from engine 12 may be transmitted to transmission 14, which in turn may be delivered to transfer case 44 via input shaft 58. Control system 24 may be provided for controlling operation of the hybrid four-wheel drive powertrain system 5. Based upon the operating information inputted to controller 30, a mode of operation of the electrified transfer case 44 may be selected and controller 30 can send electronic control signals to the various power-operated controlled devices. Specifically, controller 30 may monitor and continuously control actuation of motor/generator 22, engagement of front and rear wheel disconnects 52, 38 if present, operation of mode selection device 60, and operation of controllable clutch assembly 62.

Referring now primarily to FIG. 2, an electrified transfer case 44 is shown including electric motor 22, and a gear reduction 64 for multiplying torque from electric motor 22. Power from electric motor 22 may be coupled in various combinations to input shaft 58 and/or rear output shaft 42 based on the operating condition of mode selection device 60. A power transferring device 66 transfers power from the rear output shaft 42 to a front output shaft 56, dependent on the state of controllable clutch assembly 62. Power transferring device 66 may be as shown in these embodiments, or as an arrangement of spur or helical gears in a parallel or angled arrangement.

Electrified transfer case 44 includes a front housing 68 that receives an electric motor 22. Electric motor 22 includes a stator 70 fixed to the front housing 68. A rotor assembly 72 of the electric motor 22 is located inward from stator 70 and includes a hollow rotor shaft 74. Rotor shaft 74 is supported via a first rotor shaft bearing 76 and a second rotor shaft bearing 78, allowing rotation relative to the housings and stator 70. Electric motor 22 is controlled by controller 30. An input shaft 58 is provided which passes through hollow rotor shaft 74 and is coupled to the output of transmission 14 on a first end 82, such that electric motor 22 is positioned to be concentric or coaxial with input shaft 58. Input shaft 58 is able to rotate freely within rotor shaft 74, because an input bearing 80 provides support on the first end 82, and a needle bearing 84, disposed between the input shaft 58 and the rotor shaft 74, provides support on a second end 86.

A middle housing 88 provides support for rotor shaft 74 via second rotor shaft bearing 78 and also supports gear reduction 64, which is shown as a planetary gearset 90. Alternatively, other gear reductions, such as a layshaft, may be utilized to increase the torque provided by electric motor 22. Planetary gearset 90 includes a sun gear 92 formed integrally with or on rotor shaft 74, a ring gear 94 fixed to middle housing 88, a carrier unit 94 having a plurality of pins 96, and a plurality of planet gears 98 each rotatably mounted (via a bearing assembly) on a corresponding one of pins 96, and which are each in constant meshed engagement with sun gear 92 and ring gear 94, providing an increased ratio and multiplying the torque provided by electric motor 22.

Mode selection device 60 is provided, and includes an axially moveable sleeve 100 which has five distinct operating positions, and is moveable axially via an actuator 102. Actuator 102 may be electromechanical, electromagnetic or other type of actuator capable of moving sleeve 100 in a controlled manner through the five distinct positions. A plurality of radial clutching teeth 104 (including teeth 104A, 104B, and 104C) are provided on the outer extents of sleeve 100 which may engage into corresponding teeth of various different components, described in further detail below.

A rear housing 106 of electrified transfer case 44 is provided, which supports rear output shaft 42 for rotation via a rear output bearing 108. A support shaft 110 bridges and extends between input shaft 58 and rear output shaft 42 and is located coaxially with input shaft 58 and rear output shaft 42. The support shaft 110 is provided with a bearing 112A and 112B on each end, and is disposed within the second end 86 of input shaft 58 and the forward portion of rear output shaft 42. The support shaft 110 is disposed radially within the sleeve 100.

This support shaft 110 provides additional supportive structure between input shaft 58 and rear output shaft 42, in particular to resist the bending load from the power transfer device 66 (such as a chain). Support shaft 110 also provides support for the axially moving sleeve 100. Note that support shaft 110 is allowed to rotate relative to input shaft 58 and rear support shaft 42 when sleeve 100 is not engaged with other components.

In one aspect, sleeve 100 is in a non-relatively rotatable spline connection 101 with support shaft 110 (such that they rotate together), although a journal support providing relative rotation therebetween may also be used. In both arrangements, sleeve 100 is designed and arranged to move axially relative to support shaft 110 as controlled.

According to an aspect, because the power transferring device 66 is a chain as shown, a drive sprocket 114 is fixed with rear output shaft 42 and rotates with rear output shaft 42. A driven sprocket 116 is provided around the axis of the front output shaft 56. Driven sprocket 116 is supported for rotation around front output shaft 56 (and rotatable relative thereto) via sprocket support bearing 118. Front output shaft 56 will be supported for rotation relative to front housing 68 via bearing 120 and relative to rear housing 106 via front output rear bearing 122. Driven sprocket 116 is fixed to at least a portion of friction clutch assembly 124 of controllable clutch assembly 62.

Controllable clutch assembly 62 in this non-limiting example includes a wet-type friction clutch assembly 124 disposed between driven sprocket 116 and front output shaft 56 for facilitating adaptive torque transfer therebetween. Controllable clutch assembly 62 is actuated by clutch actuation device 126. Friction clutch assembly 124 generally includes a first clutch member or clutch drum 128 fixed for common rotation with driven sprocket 116, a second clutch member or clutch hub 130 mounted to, or formed integrally with, an intermediate section of front output shaft 56, and a multi-plate clutch pack 132 including alternatively interleaved outer clutch plates 134 and inner clutch plates 136. Outer clutch plates 134 are splined for rotation with clutch drum 128 while inner clutch plates 136 are splined for rotation with clutch hub 130. Inner clutch plates 136 may alternatively be directly splined to front output shaft 56 with hub 130 eliminated.

Controllable clutch assembly 62 is shown, in the non-limiting example of FIG. 2, to include a motor-driven rotary-to-linear conversion device of the type commonly referred to as a ballramp unit. The ballramp unit generally includes a first cam ring 138, a second cam ring 140, and followers (not shown) disposed in aligned cam tracks formed therebetween. First cam ring 138 is non-rotatably fixed to housing 88 via an anti-rotation feature. An electric actuator is utilized, based on input from controller 30, to drive and rotate second cam ring 140 and as a result of rotation of second cam ring 140 relative to first cam ring 138, a resultant axial travel and force is provided against friction clutch assembly 124. The electric actuator may be controlled to vary rotation, and therefore pressure on friction clutch assembly 124 and multi-plate clutch 132, to vary the amount of torque transferred between front output shaft 56 and driven sprocket 116.

While controllable clutch assembly 62 is shown configured as a multi-plate wet-type friction clutch assembly 124 actuated by a ball ramp, those skilled in the art will recognize that such a mechanism is intended to represent any type of actively-controlled torque transfer clutch or coupling capable of selectively coupling front output shaft 56 for rotation with driven sprocket 116, for facilitating the transfer of drive torque to front driveline 18. Other rotary-to-linear conversion devices (i.e., ballscrew units), camming devices or pivotable devices configured to control the magnitude of the clutch engagement force applied to friction clutch assembly 124 are considered alternatives for controllable clutch assembly 62. The provision of the controllable clutch assembly 62 on the front output shaft 56 results in reduced axial packaging requirements of electrified transfer case 44. Alternatively, controllable clutch assembly 62 may be placed between the drive sprocket 114 and rear output shaft 42 to perform the same functionality but resulting in an increased length electrified transfer case 44.

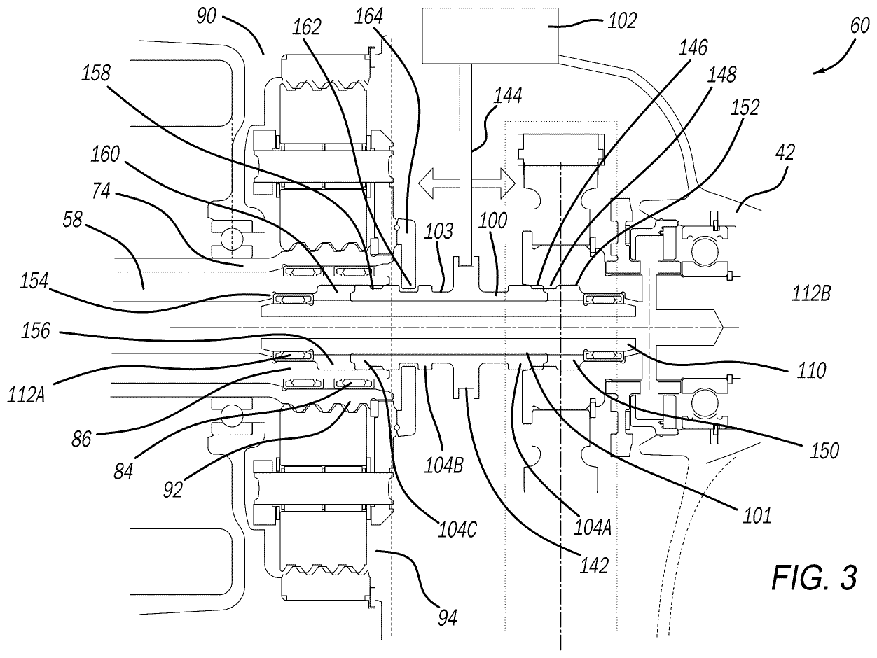

FIG. 3 provides a detailed view of mode selection device 60, to further explain the interaction of the various clutch teeth 104 of sleeve 100 with input shaft 58, carrier unit 94, and rear output shaft 42. Sleeve 100 is free to move axially along support shaft 110 relative to the fixed axial locations of input shaft 58 and rear output shaft 42, based on movement of actuator 102. Actuator 102 may be electromechanical, electromagnetic or other type of actuator capable of moving sleeve 100 in a controlled manner through the five distinct positions. Sleeve 100 may include an integral collar groove 142 receiving a fork 144, which allows sleeve 100 to rotate while actuator 102 and fork 144 are attached to a surrounding housing. In one aspect, collar groove 142 is located axially between clutch teeth 104A (disposed at the end of the sleeve 100 adjacent the rear output shaft 42) and 104B (disposed in a middle section of the sleeve 100). The arrangement of the three radial clutch teeth 104A, 104B, 104C around the outer surface of sleeve 100 are provided at different locations along the axial length of sleeve 100. These clutch teeth 104A, 104B, 104C will engage with features (such as corresponding teeth) on input shaft 58, carrier unit 94, and rear output shaft 42 based on the axial position of sleeve 100.

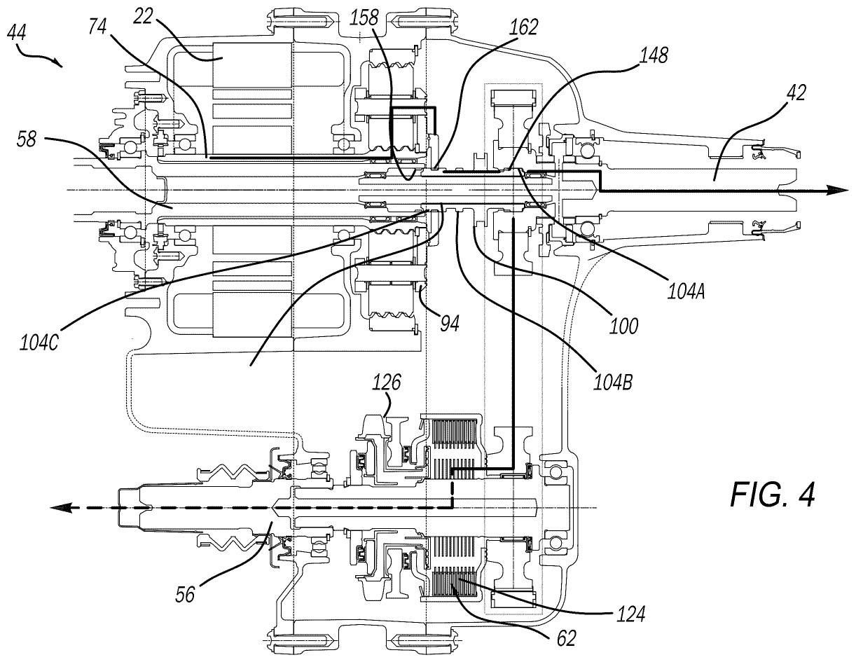

On the rearward end 146 of sleeve 100, the clutch teeth 104A are provided. Clutch teeth 104A will engage with rear output shaft inner clutch teeth 148, which are provided in a forward portion of output bore 150 of rear output shaft 42. Depending on the axial location of sleeve 100, clutch teeth 104A may be engaged with the rear output shaft inner clutch teeth 148 in a torque transmitting manner. Additionally, the rear output shaft 42 may include an annular void or clearance 152 provided in a rearward portion of output bore 150. In one aspect, in the fully rearward or fully right position in FIG. 4, the clutch teeth 104A may still engage inner clutch teeth 148 to transmit torque, and the end of the sleeve 100 is disposed in the void or clearance 152.

On the forward end 154 of sleeve 100, two other axially separated sets of radially extending clutch teeth 104B, 104C are provided to engage to either carrier unit 94 or input shaft 58, depending on the location of sleeve 100. Within input shaft bore 156 of input shaft 58, radially inward extending input shaft clutch teeth 158 are provided along a section of a rear portion of input shaft bore 156. At a forward section in bore 156, an input shaft annular void or clearance 160 is provided, which provides an area where no contact with clutch teeth 104 will occur do to the lack of clutch teeth in this area.

Sleeve 100, in a middle area, includes second radially extending clutch teeth 104B and, on the forward end 154, third radially extending clutch teeth 104C are provided. Alternatively, clutch teeth 104B, 104C may be designed to be axially extending face gear teeth, which may provide packaging or torque transmitting advantages with similar functionality.

Depending on sleeve 100 position, clutch teeth 104B may engage with carrier unit 94 via teeth 162, or to no other component. Clutch teeth 104C may engage with input shaft 58 via teeth 158, or carrier unit 94 via teeth 162. Carrier unit 94 includes carrier inner clutch teeth 162 extending inward from carrier body 164 with dimensions that allow engagement with clutch teeth 104B or 104C. Axially between clutch teeth 104B and 104C, a region with no teeth on outer surface of sleeve 100 or a neutral void 103 is provided, where in one mode such a space without teeth provides sleeve 100 a location where no engagement with carrier inner clutch teeth 162 or rear output inner clutch teeth 148 will occur.

In view of the above arrangement of teeth on the sleeve 100 and the corresponding components described above, the hybrid four-wheel drive powertrain system 5 of the present disclosure with the electrified transfer case 44 may provide various modes of operation based on the position of sleeve 100 within mode selection device 60. In one aspect, five primary modes are provided. Additional variation of the five primary modes may be provided based on the operational condition of controllable clutch assembly 62 and if motor 22 operates in a power providing or regeneration operating mode, and will be further described in the following figures. Not all modes must be utilized in electrified transfer case 22, resulting in possible simplification of sleeve 100 and other engaging components if the application does not need the full arrangement of mode possibilities. For instance, if a mode is not needed, teeth may be excluded.

FIGS. 4-8 provide further detail of the position of sleeve 100 and the resulting components that are engaged in electrified transfer case 44. Power flow through the electrified transfer case 22 is shown via bold lines and arrows and is fully described. Table 1, below, provides an overview and summary of the position of sleeve 100 relative to the engagement of clutch teeth 104 with surrounding components.

TABLE 1

| | | Sleeve 100 Clutch Teeth Engagement | | | |
|---|---|---|---|---|---|
| FIG. | Sleeve 100 Position | Mode | 104C | 104B | 104A |
| 4 | Fully Right/Rearward | EV | Carrier Inner | None | Rear Output Inner |
| | | | Clutch Teeth 162 | | Teeth 148 |
| 5 | | Hybrid | Input Teeth 158 & | None | Rear Output Inner |
| | | | Carrier Teeth 162 | | Teeth 148 |
| 6 | | Conventional | Input Shaft Inner | None | Rear Output Inner |
| | | | Clutch Teeth 158 | | Teeth 148 |
| 7 | | Generator/Flat Tow | Input Shaft Inner | Carrier Inner | Rear Output Inner |
| | | | Clutch Teeth 158 | Clutch Teeth 162 | Teeth 148 |
| 8 | Fully Left/Forward | Neutral Flat Tow | None | None | None |

With reference to FIG. 4, an EV mode of operation, where electric motor 22 provides the sole source of propulsion for hybrid powertrain system 5, will now be discussed in greater detail. Sleeve 100 is controllably moved in the fully rearward, or towards the right in FIG. 4, by actuator 102. The clutch teeth 104A engage with the rear output shaft inner teeth 148, and, on the left in FIG. 4, clutch teeth 104C engage with carrier inner clutch teeth 162. Clutch teeth 104B are not engaged. Input shaft 58, connected to the internal combustion engine 12 via transmission 14, does not transmit power into electrified transfer case 44 because there is no engagement between input shaft 58 and sleeve 100. Controller 30 drives electric motor 22, thereby in turn driving planetary 90, where torque is provided via carrier unit 94 to sleeve 100 via teeth 104C and 162, and onto the rear output shaft 42 via teeth 104A and 148, with torque increased based on the ratio of planetary 90. Dependent on the operational state of controllable clutch assembly 62, the power provided by electric motor 22 may be distributed fully to rear output shaft 42 and rear axle 34 to provide a 2WD EV mode or, with a variable force applied by clutch actuator device 126 to frictional clutch 124, torque may also be controllably distributed to the front output shaft 56 and front axle 48, providing an all-wheel or four wheel drive operating condition in EV. In this EV mode, electric motor 22 may be back driven by hybrid powertrain system 5 during braking events, generating power back to battery 26.

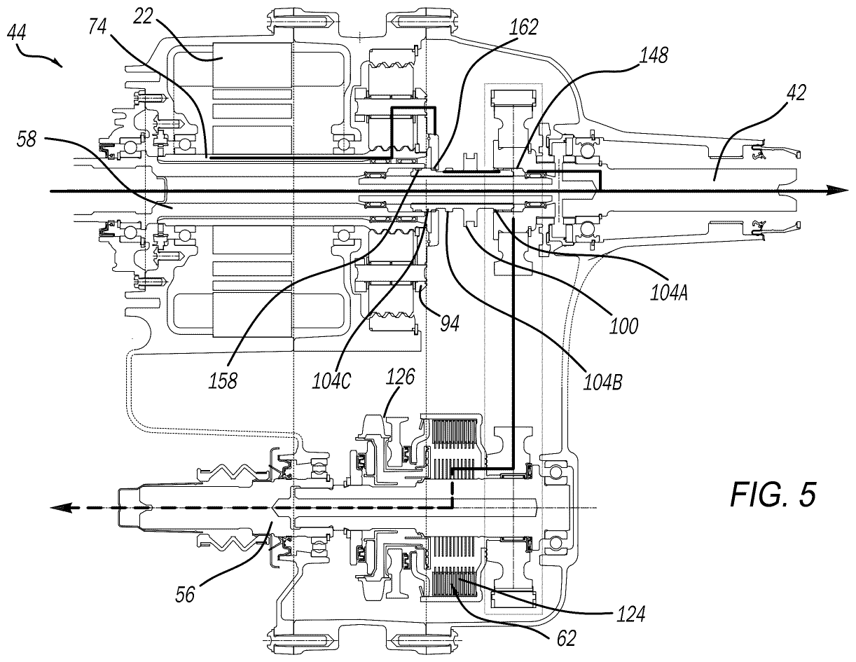

With reference to FIG. 5, a hybrid mode of operation is shown, where electric motor 22 and internal combustion engine 12 both provide the source of propulsion for hybrid powertrain system 5, and will now be described. Sleeve 100 is moved relatively forward from EV mode or towards the left in FIG. 5 by actuator 102. The clutch teeth 104A continue to be engaged with the rear output shaft inner teeth 148, and clutch teeth 104C are still engaged with carrier inner clutch teeth 162, and clutch teeth 104C are also engaged with input shaft inner clutch teeth 158. Clutch teeth 104B continue to not be engaged. Input shaft 58, in this mode of operation, is connected to the internal combustion engine 12 and transmits power into electrified transfer case 44 due to the engagement between input shaft 58 and sleeve 100 by clutch teeth 104C and 158. Electric motor 22, as required to boost overall power for hybrid powertrain system 5 by controller 30, drives planetary 90, providing increased torque to rear output shaft 42 from carrier unit 94 connection to sleeve 100 via clutch teeth 104C and 162. The increased electric motor 22 torque is transferred to rear output shaft 42 by sleeve 100 via clutch teeth 104A and 148. Dependent on the operational state of controllable clutch assembly 62, the power provided by electric motor 22 and engine 12 may be distributed fully to rear output shaft 42 and rear axle 34 to provide a 2WD hybrid mode or, with a variable force applied by clutch actuator device 126 to frictional clutch 124, torque may also be controllably distributed to the front output shaft 56 and front axle 48 providing an all-wheel or four wheel drive operating condition in hybrid operating condition. In this hybrid mode, electric motor 22 may be back driven by hybrid powertrain system 5 during braking events, generating power back to battery 26.

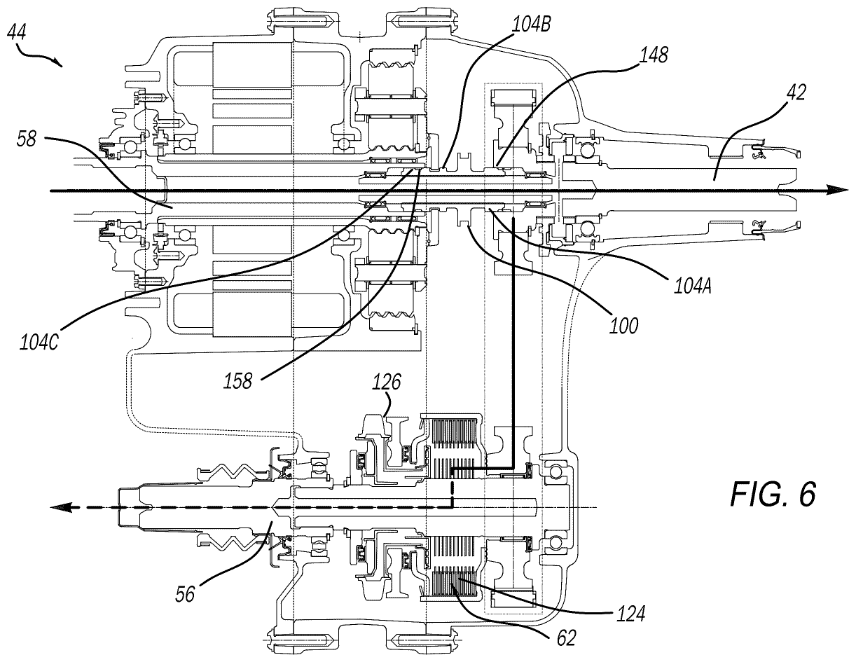

FIG. 6 provides a conventional operating mode, where only the internal combustion engine 12 will provide the source of propulsion for hybrid powertrain system 5. Sleeve 100 is moved forward from hybrid mode or towards the left by actuator 102. The clutch teeth 104A continue to be engaged with the rear output shaft inner teeth 148, and clutch teeth 104C are engaged with only input shaft inner clutch teeth 158. The carrier inner clutch teeth 162 and planetary 90 are not engaged, and clutch teeth 104B of sleeve 100 will continue to not be engaged. Input shaft 58, connected to the internal combustion engine 12 via transmission 14, transmits power into electrified transfer case 44 due to the engagement between input shaft 58 and sleeve 100 by clutch teeth 104C and 158. Power is transmitted by sleeve 100 into rear output shaft 42 via clutch teeth 104A and 148. Dependent on the operational state of controllable clutch assembly 62, the power provided by engine 12 may be distributed fully to rear output shaft 42 and rear axle 34 to provide a 2WD mode or, with a variable force applied by clutch actuator device 126 to frictional clutch 124, torque may also be controllably distributed to the front output shaft 56 and front axle 48 providing an all-wheel or four wheel drive operating condition operating condition.

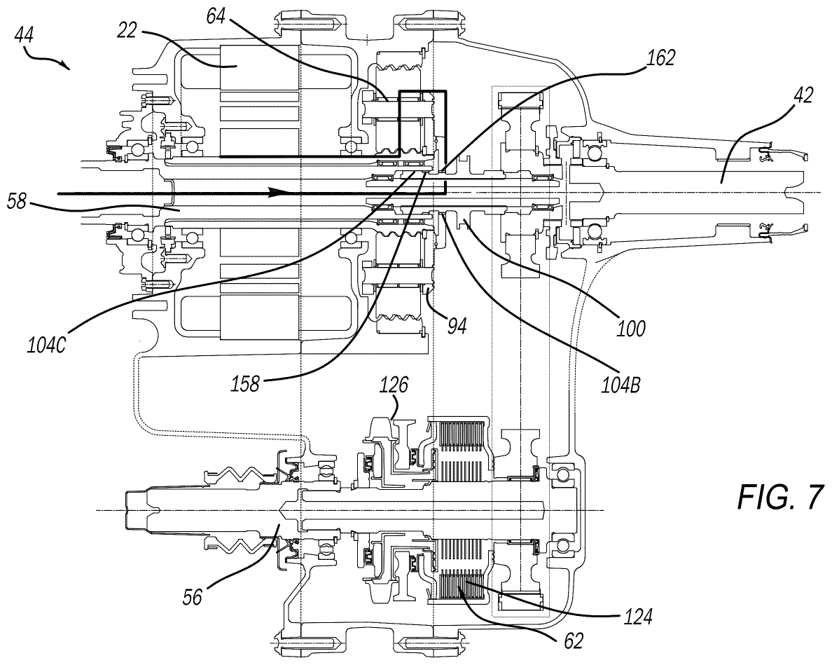

FIG. 7 provides a fourth operating mode, where only input shaft 58 is connected to electric motor 22 via planetary 90. Sleeve 100 is moved forward or towards the left by actuator 102 from the conventional operating mode of FIG. 6. The clutch teeth 104A are not engaged with any component. Clutch teeth 104B, however, are engaged with carrier unit 94 via the carrier inner clutch teeth 162. Clutch teeth 104C are engaged to input shaft inner clutch teeth 158. Controllable clutch assembly 62 may remain fully open and not actuated. This results in two possible operating modes with sleeve 100 in this fourth position.

The first operating mode of this position of FIG. 7 is a generating mode, where engine 12 may use electric motor 22 as a generator to charge battery 26. This is used by control 30 to run engine 12 when the vehicle is stationary with transmission 14 engaged. Because there is no power transfer from input shaft 58 to rear output shaft 42 or front output shaft 56 through transfer case 44, the engine 12 may drive transmission 14 without vehicle movement. Motor 22 is back driven by input shaft 58 thru planetary 90 via the connection from input shaft 58 to sleeve 100 via clutch teeth 104C and 158 and from sleeve 100 to carrier unit 94 via clutch teeth 104B and 162.

The second operating mode, when sleeve 100 is the position of FIG. 7 is to provide a flat towing capability. Flat towing is the case where both front 48 and rear axles 34 are back driven by the road surface as the vehicle is being towed. In such a condition, it is advantageous to provide an operational condition of the electrified transfer case 44 where the input shaft 58, and therefore transmission 14, will not be back driven by the movement of axles 34 and 48. Because there is no connection of rear output shaft 42 to sleeve 100, it is not possible to back drive input shaft 58. While planetary 90 and electric motor 22 remain engaged due to the connection of clutch teeth 104B and carrier inner clutch teeth 162, controller 30 may deenergize electric motor 22, such that battery 26 is not charged as in the first operating mode of the same sleeve 100 position. In one aspect, it would be advantageous to utilize an electric motor 22 technology such as an asynchronous motor where back driving will not create a back EMF.

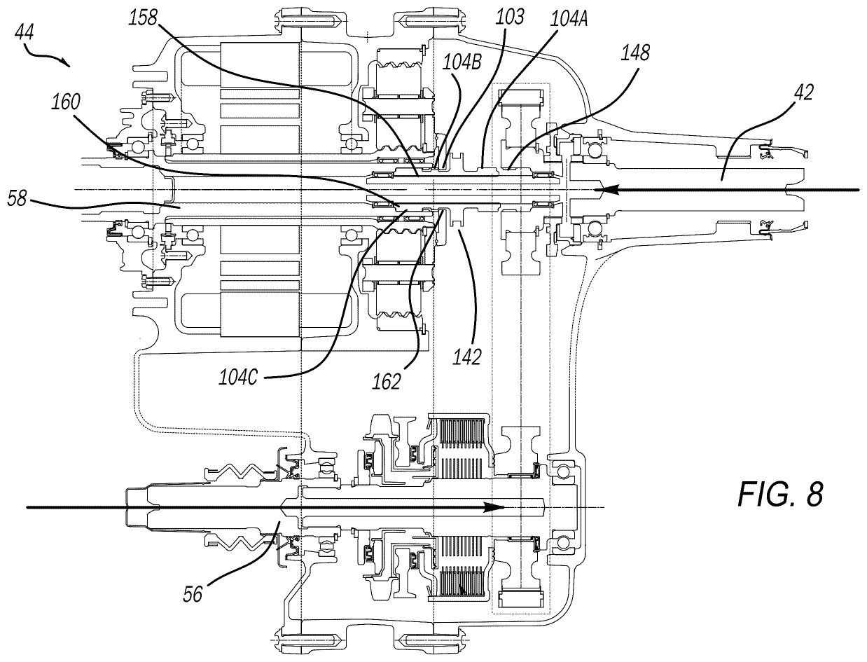

FIG. 8 illustrates a fifth operating mode, providing a true neutral mode of electrified transfer case 44. Sleeve 100 is moved to the furthest forward or fully towards the left by actuator 102. Controllable clutch assembly 62 may remain fully open and not actuated. The clutch teeth 104A, 104B, and 104C of sleeve 100 have no engagement to input shaft 58, rear output 42, and front output 56, thereby providing a true neutral. This is achieved because clutch teeth 104A are not engaged with rear output shaft 42 or clutch teeth 148 as in previous modes. Additionally, carrier inner clutch teeth 162 are not engaged to sleeve 100 via teeth 104B, because teeth 162 are located axially aligned with the neutral void 103, which is provided on sleeve 100 between collar groove 142 and clutch teeth 104B. Also, clutch teeth 104C are axially aligned with the input shaft inner void 160, resulting in no connection with input shaft 58. This provides a somewhat similar arrangement to the previously described mode providing flat tow capability, but eliminates the connection between carrier inner clutch teeth 162 with sleeve 100 so motor 22 will be stationary and not back driven. In one aspect, this arrangement may provide alternatives to the types of motor 22 technology used during flat tow situations.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

What is claimed is:

1. An electrified transfer case for a vehicle having an engine, a transmission, and front and rear drivelines, comprising:
an input shaft configured to receive motive power from the transmission;
a first output shaft configured to connect to the front or rear driveline;
an electric motor coaxially arranged around the input shaft and fixed for rotation to a gear reduction unit;
a mode selection device including an actuator and an axially moveable sleeve, wherein the sleeve is axially moveable relative to the input shaft, the gear reduction unit, and the first output shaft for selective engagement with each of the input shaft, the gear reduction unit, and the first output shaft depending on an axial position of the sleeve;
wherein the sleeve has multiple axial positions, wherein each axial position of the multiple axial positions defines a different torque transferring mode of operation.

2. The transfer case of claim 1, further comprising:
a second output shaft configured to connect to the front or rear driveline; and
a power transfer device configured to connect the first output shaft to the second output shaft.

3. The transfer case of claim 2, wherein the power transfer device selectively connects the first output shaft to the second output shaft via a controllable clutch assembly.

4. The transfer case of claim 1, wherein the input shaft has a forward end adapted for connection to the transmission, and a rearward end adapted for selective connection to the sleeve.

5. The transfer case of claim 4, wherein the first output shaft has a forward end configured for selective connection to the sleeve, and a rearward end configured for connection to the front or rear driveline.

6. The transfer case of claim 1, wherein the sleeve is supported on and is axially slidable relative to a support shaft, wherein the support shaft spans between the input shaft and the first output shaft, wherein the support shaft is freely rotatable between the rearward end of the input shaft and the forward end of the first output shaft, wherein the sleeve is freely rotatable relative to the support shaft.

7. The transfer case of claim 1, wherein the sleeve includes a collar groove, wherein the actuator includes an axially shiftable shift fork that engages the collar groove, wherein the collar groove and sleeve are rotatable together relative to the shift fork.

8. The transfer case of claim 1, wherein the sleeve includes multiple sets of clutch teeth disposed at different axial locations along the sleeve on an outer surface of the sleeve, wherein different sets of the multiple sets of clutch teeth selectively engage inner clutch teeth of the input shaft, first output shaft, and gear reduction unit depending on the axial position of the sleeve.

9. The transfer case of claim 8, wherein the multiple sets of clutch teeth include first clutch teeth that selectively engage the inner clutch teeth of the first output shaft based on the axial position of the sleeve.

10. The transfer case of claim 9, wherein the multiple sets of clutch teeth include second clutch teeth that selectively engage the gear reduction unit based on the axial position of the sleeve.

11. The transfer case of claim 10, wherein the multiple sets of clutch teeth include third clutch teeth that selectively engage the input shaft based on the axial position of the sleeve and electively engage the gear reduction unit based on the axial position of the sleeve.

12. The transfer case of claim 11, wherein both the second clutch teeth and the third clutch teeth electively engage the gear reduction unit based on the axial position of the sleeve.

13. The transfer case of claim 8, wherein the multiple axial positions include:
a first axial position, wherein the clutch teeth of the sleeve drivingly engage the first output shaft and the gear reduction unit, and do not drivingly engage the input shaft, to operate in an EV mode;
a second axial position, wherein the clutch teeth of the sleeve drivingly engage the first output shaft, the gear reduction unit, and the input shaft to operate in a hybrid mode;
a third axial position, wherein the clutch teeth of the sleeve drivingly engage the first output shaft and the first input shaft, and do not drivingly engage the gear reduction unit, to operate in a conventional mode;
a fourth axial position, wherein the clutch teeth of the sleeve driving engage the gear reduction unit and the input shaft, and do not drivingly engage the first output shaft, to operate in a generator or flat tow mode; and
a fifth axial position, wherein the clutch teeth of the sleeve do not drivingly engage the first output shaft, the gear reduction unit, and the input shaft to operate in a neutral mode.

14. The transfer case of claim 13, wherein in the fourth and fifth axial position, the first output shaft is drivingly decoupled from the input shaft and the electric motor, such that rotation of the first output shaft does not backdrive the electric motor and transmission.

15. The transfer case of claim 13, further comprising
a second output shaft configured to connect to the front or rear driveline; and
a power transfer device configured to connect the first output shaft to the second output shaft,
wherein the power transfer device selectively connects the first output shaft to the second output shaft via a controllable clutch assembly;
wherein the controllable clutch assembly is controlled to distribute power between the first and second output shafts to operate in a four wheel drive or all-wheel drive mode when the sleeve is one of the first, second, and third axial positions.

16. The transfer case of claim 15, wherein the controllable clutch assembly is controlled to be in the open position when the sleeve is in the fourth or fifth axial position, wherein the front and rear drivelines are each independently rotatable and decoupled to facilitate a flat towing operation.

17. The transfer case of claim 13, wherein multiple modes of operation are enabled when the sleeve is in the fourth axial position, wherein the transfer case operates as a generator when the transmission provides power via the input shaft, which is transferred to the electric motor via the gear reduction unit, and the first output shaft does not rotate, and the transfer case operates in a flat tow mode when the first output shaft rotates without transferring torque to the input shaft or gear reduction unit.

18. The transfer case of claim 1, wherein the gear reduction unit is a planetary gearset, wherein the sleeve selectively engages a carrier of the planetary gearset based on the axial position of the sleeve.

19. The transfer case of claim 1, wherein the first output shaft is a rear output shaft, and a front output shaft is connected to the rear output shaft via a power transfer device having a controllable clutch assembly for selectively operating in one of a rear wheel drive mode, four wheel drive mode, or all wheel drive mode.

20. The transfer case of claim 12,
wherein a void is defined between the second clutch teeth and the third clutch teeth, wherein the third clutch teeth engage the gear reduction unit in a first axial position of the sleeve,
wherein the third clutch teeth engage both the gear reduction unit and the input shaft in a second axial position of the sleeve,
wherein neither the second or third clutch teeth engage the gear reduction unit in a third axial position and the void is aligned with inner clutch teeth of the gear reduction unit and the third clutch teeth engage the input shaft in the third axial position,
wherein the second clutch teeth are engaged with the gear reduction unit in a fourth axial position and the third clutch teeth are engaged with the input shaft in the fourth axial position;
wherein the first clutch teeth are engaged with the first output shaft in the first, second, third, and fourth axial position;
wherein all of the first, second, and third clutch teeth are disengaged from the input shaft, first output shaft, and gear reduction unit in a fifth axial position of the sleeve, wherein the third clutch teeth are disposed within a void formed in input shaft, the inner clutch teeth of gear reduction unit are axially offset from the second clutch teeth, and the first clutch teeth are axially offset from inner clutch teeth of the first output shaft.
